(19) United States
(12) Patent Application Publication
(10) Pub. No.: US 2022/0236425 A1
(43) Pub. Date: Jul. 28, 2022

(54) DETECTION OF SPOOFING ATTACKS ON SATELLITE NAVIGATION SYSTEMS

(71) Applicant: Regulus Cyber Ltd., Haifa (IL)

(72) Inventors: Yoav ZANGVIL, Haifa (IL); Avner ZANGVIL, Ramat-HaSharon (IL); Stanislav GUTLIANSKY, Haifa (IL); Dror KATALAN, Shavei Tzion (IL); Gal COHEN, Haifa (IL); Alon ATSMON, Kiryat Ono (IL)

(73) Assignee: Regulus Cyber Ltd., Haifa (IL)

(21) Appl. No.: 17/612,618

(22) PCT Filed: May 21, 2020
(86) PCT No.: PCT/IL2020/050562

§ 371 Date: Nov. 19, 2021

Related U.S. Application Data
(60) Provisional application No. 62/966,072, filed on Jan. 27, 2020.
(60) Provisional application No. 62/850,578, filed on May 21, 2019.

(51) Int. Cl. G01S 19/21; G01S 19/47

(52) U.S. Cl. CPC G01S 19/215; G01S 19/47

(57) ABSTRACT

An attack detector for detecting attacks on a satellite navigation system obtains navigation messages extracted from satellite navigation signals and/or additional parameters of the satellite navigation signal from source devices. The obtained navigation messages and/or parameters are analyzed to detect satellite navigation spoofing attacks. An indicator is issued when an attack is detected.

### RELATED APPLICATIONS SECTION

This application claims the benefit of priority of U.S. Provisional Patent Application No. 62/850,578 filed on 21 May 2019, the contents of which are incorporated herein by reference in their entirety.

This application claims the benefit of priority of U.S. Provisional Patent Application No. 62/966,072 filed on 27 Jan. 2020, the contents of which are incorporated herein by reference in their entirety.

### FIELD AND BACKGROUND OF THE INVENTION

The present invention, in some embodiments thereof, relates to detecting satellite navigation spoofing attacks and, more specifically, but not exclusively, to detecting satellite navigation spoofing attacks by combining multiple types of analysis of parameters extracted from satellite navigation signals.

Global Navigation Satellite System (GNSS) spoofing refers to the generation and transmission of GNSS signals in a way that causes GNSS receiver to receive them, validate them and use them to calculate and report the wrong position or time. Until recently, GNSS spoofing attacks required many resources and expensive equipment and was usually reserved for the military, other government agencies and well-funded organizations. However, in recent years low-cost software defined radios (SDR) and open-source GPS simulators have become widely available. This has led to an increasing occurrence of non-military GNSS spoofing attacks.

GNSS receivers are designed to provide navigation data, and typically do not have the ability to detect spoofing attacks. One of the main reasons is the difficulty and complexity of reliable detection. Another reason is a requirement by manufacturers to allow easy testing of their receivers using GNSS simulators. In order to allow ease of testing, many parameters inside the receiver are not optimized (e.g., the automatic gain control range is very broad).

There are some military solutions utilizing controlled radiation-pattern antenna (CRPA) technology that, by design, combat jamming attacks. Another solution is to drop satellite navigation data suspected of being spoofed and not use it to calculate the geographic location.

Fugro's Satguard™ applies a dedicated network of more than 100 reference stations world-wide to monitor the status of and data received from each individual GNSS satellite. Using Navigation Message Authentication a unique signature for each satellite is transmitted to users. By comparing the satellite data seen by the user with the data provided by Satguard™ fake satellites may be identified and discarded. Satguard™ also uses a multi-receiver technique which compares GNSS antenna geometry with known offsets. If one or more antennas depart from the expected location the system will trigger a spoofing alert. Satguard™ uses a large dedicated infrastructure of reference stations, with the attendant costs and technical difficulties of maintaining such a complex infrastructure.

Many systems rely on GNSS signals both for timing and location. As the spoofing threat is now at the hands of non-military hackers, a solution to identify and mitigate GNSS spoofing attacks is needed.

Additional background art includes:
[1] E. Shafiee, M. R. Mosavi and M. Moazedi, “Detection of Spoofing Attack using Machine Learning based on Multi-Layer Neural Network in Single-Frequency GPS Receivers,” in THE JOURNAL OF NAVIGATION, Page 1 of 20. The Royal Institute of Navigation 2017.
[2] Yang Liu, Sihai Li, Qiangwen Fu, and Zhenbo Liu, “Impact Assessment of GNSS Spoofing Attacks on INS/GNSS Integrated Navigation System,” in Sensors (Basel), 18(5): 1433, May 4, 2018.

### SUMMARY OF THE INVENTION

It is an object of the present invention to provide an apparatus and method for detecting a GNSS spoofing attack. When such an attack is detected, control actions may be taken to mitigate the adverse effects.

Embodiments of the invention presented herein include many analysis mechanisms which be used alone or in combination to detect attacks on satellite navigation systems. The analysis may operate on information gathered from multiple sources and may be optimized to provide high detection accuracy for specific cases.

An indicator is issued when an attack is detected.

Benefits of the invention include:

1) The ability to mitigate the effects of a detected attack by providing an indicator of the attack within a time frame which allows the device using satellite navigation to respond in real-time to the attack;

2) Increased reliability of the geographic location decoded by the GNSS receiver;

3) More trustworthy navigation data reduces the need for other sensors or techniques for identifying the location;

4) False positives are minimized by using data from many sources; and

5) Easily implemented, without need for an extensive proprietary monitoring and data collection infrastructure.

According to a first aspect of some embodiments of the present invention there is provided a device for detecting attacks on a satellite navigation system. The device includes processing circuitry configured to:
obtain parameters extracted from at least one satellite navigation signal, the parameters including navigation messages;
input the obtained parameters into a classifier for detecting attacks on the satellite navigation system, wherein the classifier detects an attack by analyzing data sequences which repeat at a same location in a plurality of corresponding navigation messages; and
issue an indicator when an attack is detected by the classifier.

According to some embodiments of the first aspect of the invention the device further includes a GNSS receiver.

According to some embodiments of the first aspect of the invention the device further includes a communication interface configured to communicate with a GNSS receiver.

According to a second aspect of some embodiments of the present invention there is provided a method for detecting attacks on a satellite navigation system. The method includes:

obtaining parameters extracted from a satellite navigation signal, the parameters including navigation messages;

inputting the obtained parameters into a classifier for detecting attacks on the satellite navigation system, wherein the classifier detects the attacks by analyzing data sequences which repeat at a same location in a plurality of corresponding navigation messages; and

based on a result from the classifier, issuing an indicator when an attack is detected by the classifier.

According to some embodiments of the first and/or second aspect of the invention, the location of the analyzed data sequences is a location having undefined data content in the protocol of the satellite navigation system.

According to some embodiments of the first and/or second aspect of the invention, the classifier detects the attack when the data sequences at the same location are extracted from navigation messages having the same transmission time information and which were received by a plurality of geographically dispersed GNSS receivers.

According to some embodiments of the first and/or second aspect of the invention, the classifier detects the attack when the data sequences at the same location correspond to a specified sequence.

According to some embodiments of the first and/or second aspect of the invention, the indicator is issued to a device enabled for satellite navigation and includes a trigger signal to trigger mitigating actions against the attack at the device enabled for satellite navigation.

According to some embodiments of the first and/or second aspect of the invention, the obtained parameters include at least one of:

navigational information computed by the GNSS receiver;

a navigation message;

characteristics of the received satellite signal; and

data decoded from the satellite signal.

According to some embodiments of the first and/or second aspect of the invention, the classifier includes a neural network trained to detect attacks on the satellite navigation system by a machine learning algorithm using training data which includes a plurality of parameters indicative of attacks on the satellite navigation system.

According to some embodiments of the first and/or second aspect of the invention, the analysis includes applying rule-based analysis to at least some of the obtained parameters.

According to some embodiments of the first and/or second aspect of the invention, the analysis includes assessing the validity of at least one of the obtained parameters in accordance with a model of an expected behavior of the obtained parameters.

According to some embodiments of the first and/or second aspect of the invention, upon the issue of the indicator of an attack a control action is performed in order to mitigate the attack.

According to some embodiments of the first and/or second aspect of the invention, at least one additional input parameter is obtained from at least one external source. The at least one additional parameter is input to the classifier, and the detection by the classifier is based on the parameters extracted from the at least one satellite navigation signal and on the parameters obtained from the at least one external source. According for further embodiments of the invention, at least one external source is:

a mobile communication device;

a mobile communication cell tower;

a navigation device;

a motion sensor;

a rotation sensor;

a magnetic sensor;

an odometer;

an inertial measurement unit;

a barometer;

a compass;

a steering wheel angle sensor;

a camera; and

at least one localization image.

According to some embodiments of the first and/or second aspect of the invention, parameters extracted from respective satellite navigation signals are obtained from multiple client devices. A query is received from one of the client devices querying whether a navigation message provided to the client device is a legitimate navigation message. The navigation message and respective parameters obtained from at least one other of the client devices are input into the classifier. An indicator of an illegitimacy of the navigation message is returned to the querying client device when the classifier detects an attack.

According to some embodiments of the first and/or second aspect of the invention, the classifier determines a legitimacy of the navigation message based on a consensus of multiple corresponding navigation messages obtained from the other client devices.

According to some embodiments of the first and/or second aspect of the invention, at least one of the client devices is polled to obtain the parameters extracted from the respective satellite navigation signals.

According to a third aspect of some embodiments of the present invention there is provided a device for detecting attacks on a satellite navigation system. The device includes processing circuitry configured to:

obtain, from a Global Navigation Satellite System (GNSS) receiver, parameters extracted from a satellite navigation signal;

input the obtained parameters into a classifier trained to detect attacks on satellite navigation systems, wherein the classifier is trained using a training set that includes parameters indicative of the presence of attacks; and

based on a result from the classifier, issue an indicator when an attack is detected.

According to some embodiments of the first aspect of the invention, the GNSS receiver is internal to the device.

According to some embodiments of the first aspect of the invention the device further includes a communication interface configured to communicate with the GNSS receiver.

According to a fourth aspect of some embodiments of the present invention there is provided a method for detecting attacks on a satellite navigation system. The method includes:

obtaining, from a Global Navigation Satellite System (GNSS) receiver, parameters extracted from a satellite navigation signal;

inputting the obtained parameters into a classifier trained to detect attacks on satellite navigation systems, wherein the classifier is trained using a training set that includes parameters indicative of the presence of attacks; and

based on a result from the classifier, issuing an indicator when an attack is detected.

According to some embodiments of the third and/or fourth aspect of the invention, the obtained parameters include at least one of:

navigational information computed by the GNSS receiver;

a navigation message;

characteristics of the received satellite signal; and

data decoded from the satellite signal.

According to some embodiments of the third and/or fourth aspect of the invention, the classifier includes a neural network trained with the training data by a machine learning algorithm.

According to some embodiments of the third and/or fourth aspect of the invention, the classifier applies rule-based analysis to at least some of the obtained parameters.

According to some embodiments of the third and/or fourth aspect of the invention, the classifier assesses a validity of at least some of the obtained parameters in accordance with a model of an expected behavior of the obtained parameters.

According to some embodiments of the third and/or fourth aspect of the invention, wherein, upon the issue of the indicator of an attack, a control action is performed to mitigate the attack.

According to some embodiments of the third and/or fourth aspect of the invention, at least one additional input parameter is obtained from at least one external source. The at least one additional parameter is input to the classifier. The detecting by the classifier is based on the parameters obtained from the GNSS receiver and on the parameters obtained from the at least one external source.

According to some embodiments of the third and/or fourth aspect of the invention, at least one external source is:

a mobile communication device;

a mobile communication cell tower;

a navigation device;

a motion sensor;

a rotation sensor;

a magnetic sensor;

an odometer;

an inertial measurement unit;

a barometer;

a compass;

a steering wheel angle sensor;

a camera; and

at least one localization image.

According to some embodiments of the third and/or fourth aspect of the invention:

parameters extracted from respective satellite navigation signals are obtained from multiple client devices,

a query is received from one of the client devices whether a navigation message provided to the client device comprises a legitimate navigation message;

the navigation message and respective parameters obtained from at least one other of the client devices are input into the classifier; and

an indicator of an illegitimacy of the navigation message is returned to the querying client device when the classifier detects an attack.

According to some embodiments of the third and/or fourth aspect of the invention the classifier determines the legitimacy of the navigation message based on a consensus of a corresponding navigation messages obtained from other client devices.

According to some embodiments of the third and/or fourth aspect of the invention at least one of the client devices is polled to provide the parameters extracted from the respective satellite navigation signals.

According to a fifth aspect of some embodiments of the present invention there is provided a device for detecting attacks on a satellite navigation system. The device includes processing circuitry configured to:
obtain, from a Global Navigation Satellite System (GNSS) receiver, parameters extracted from a satellite navigation signal;
input the obtained parameters into a classifier trained to detect attacks on satellite navigation systems, wherein the classifier is trained using a training set comprising a plurality of parameters indicative of the presence of attacks; and
based on a result from the classifier, issue an indicator when an attack is detected.

According to some embodiments of the invention the obtained parameters include navigational information computed by the GNSS receiver.

According to some embodiments of the invention the obtained parameters include characteristics of the received satellite signal.

According to some embodiments of the invention the obtained parameters include data decoded from the satellite signal.

According to some embodiments of the invention the classifier includes a neural network trained with the training data by a machine learning algorithm.

According to some embodiments of the invention the classifier applies rule-based analysis to at least some of the obtained parameters.

According to some embodiments of the invention the classifier assesses a validity of at least some of the obtained parameters in accordance with a model of an expected behavior of the obtained parameters.

According to some embodiments of the invention, upon the issue of the indicator of an attack, the processing circuitry performs a control action to mitigate the attack.

According to some embodiments of the invention the processing circuitry obtains at least one additional input parameter from at least one external source and inputs the at least one additional parameter to the classifier. The detection by the classifier is based on the parameters obtained from the GNSS receiver and on the parameters obtained from the at least one external source.

According to some embodiments of the invention at least one external source is:

a mobile communication device;

a mobile communication cell tower;

a navigation device;

a motion sensor;

a rotation sensor;

a magnetic sensor;

an odometer;

an inertial measurement unit;

a barometer;

a compass;

a steering wheel angle sensor;

a camera; and

at least one localization image.

According to some embodiments of the invention the GNSS receiver is internal to the device.

According to some embodiments of the invention the device further includes a communication interface configured to communicate with the GNSS receiver.

According to a sixth aspect of some embodiments of the present invention there is provided a method for detecting attacks on a satellite navigation system. The method includes:

obtaining, from a Global Navigation Satellite System (GNSS) receiver, parameters extracted from a satellite navigation signal;

inputting the obtained parameters into a classifier trained to detect attacks on satellite navigation systems, wherein the classifier is trained using a training set comprising a plurality of parameters indicative of the presence of attacks; and

based on a result from the classifier, issuing an indicator when an attack is detected.

According to some embodiments of the invention the obtained parameters include navigational information computed by the GNSS receiver.

According to some embodiments of the invention the obtained parameters include characteristics of the received satellite signal.

According to some embodiments of the invention the obtained parameters include data decoded from the satellite signal.

According to some embodiments of the invention the classifier includes a neural network trained with the training data by a machine learning algorithm.

According to some embodiments of the invention the classifier applies rule-based analysis to at least some of the input parameters.

According to some embodiments of the invention the classifier assesses a validity of at least some of the obtained parameters in accordance with a model of an expected behavior of the obtained parameters.

According to some embodiments of the invention the method further includes performing a control action to mitigate the attack upon an issue of the indicator of an attack.

According to some embodiments of the invention the method further includes obtaining at least one additional input parameter from at least one external source and inputting the at least one additional parameter to the classifier, the detecting by the classifier being based on the parameters obtained from the GNSS receiver and on the parameters obtained from the at least one external source.

According to a seventh aspect of some embodiments of the present invention there is provided an attack detector for detecting attacks on a satellite navigation system. The attack detector includes a communication interface configured for communicating over a network and processing circuitry. The processing circuitry:

obtains, over the network, navigation messages extracted from satellite navigation signals by a plurality source devices;

selects a consensus navigation message from a set of the obtained navigation messages by majority selection; and

sending an indicator of a spoofing attack to at least one source device when a navigation message obtained from the source device differs from the consensus navigation message.

According to some embodiments of the invention the set includes a single navigation message for each respective source device and the consensus navigation message is the navigation message having a maximum count in the set.

According to some embodiments of the invention for each of the source devices the set includes a specified multiple of the navigation message obtained from the source device and the consensus navigation message is the navigation message having a maximum count in the set.

According to some embodiments of the invention set includes navigation messages having the same Time Of Week.

According to some embodiments of the invention the processing circuitry is further configured for detecting spoofed navigation messages by analyzing parameters obtained from a GNSS receiver. Optionally, the obtained parameters include at least one of:

navigational information computed by the GNSS receiver;

physical characteristics of the received satellite signal; and

data decoded from the satellite signal.

According to some embodiments of the invention the processing circuitry is further configured for detecting spoofed navigation messages by analyzing sensor data obtained from at least one of the source devices. Optionally, the sensor data is from an inertial measurement unit.

According to some embodiments of the invention the processing circuitry is further configured for preventing inclusion of the spoofed navigation messages in the set.

According to an eighth aspect of some embodiments of the present invention there is provided a satellite navigation device which includes a GNSS receiver, a communication network for communicating over a network, and processing circuitry. The Global Navigation Satellite System (GNSS) receiver receives satellite navigation signals and extracts navigation messages from the satellite navigation signal. The processing circuitry:

sends the extracted navigation messages to a navigation message analyzer over the network;

obtains a consensus navigation message and a timing parameter of the consensus navigation message from the navigation message analyzer;

detects a spoofing attack when an extracted navigation message corresponding to the timing parameter of the consensus navigation message differs from the consensus navigation message. Optionally, the timing parameter is the Time Of Week of the navigation message.

According to some embodiments of the invention the processing circuitry is further configured for periodically pushing extracted navigation messages to the navigation message analyzer.

According to a ninth aspect of some embodiments of the present invention there is provided a method for detecting attacks on a satellite navigation system. The method includes:

obtaining, from multiple source devices, navigation messages extracted from satellite navigation signals;

selecting a consensus navigation message from a set of the obtained navigation message by majority selection;

sending an indicator of a spoofing attack to at least one source device when a navigation message obtained from the source device differs from the consensus navigation message.

According to some embodiments of the invention the set includes a single navigation message for each respective source device and the consensus navigation message is the navigation message having a maximum count in the set.

According to some embodiments of the invention the set includes a specified multiple of the respective navigation message obtained from each of the source devices device and the consensus navigation message is the navigation message having a maximum count in the set.

According to some embodiments of the invention the set includes navigation messages having the same Time Of Week.

According to some embodiments of the invention the method further includes detecting spoofed navigation messages by analyzing parameters obtained from a GNSS receiver. Optionally the obtained parameters include at least one of:

navigational information computed by the GNSS receiver;

physical characteristics of the received satellite signal; and

data decoded from the satellite signal.

According to some embodiments of the invention the method further includes detecting spoofed navigation messages by analyzing sensor data obtained from at least one of the source devices.

According to some embodiments of the invention the method further includes preventing inclusion of the spoofed navigation messages in the set.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified block diagram of a device for detecting attacks on a satellite navigation system, according to embodiments of the invention;

FIG. 1B is a simplified block diagram of a satellite navigation device, according to embodiments of the invention;

FIG. 1C is a simplified block diagram of an attack detector in communication with a GNSS receiver, according to an exemplary embodiment of the invention;

FIG. 2A is a simplified block diagram of a device for detecting attacks on a satellite navigation system, according to exemplary embodiments of the invention;

FIG. 2B is a simplified block diagram of a satellite navigation device, according to exemplary embodiments of the invention;

FIG. 3 is a simplified block diagram of an attack detector receiving information from multiple sources;

FIGS. 4-7 are simplified flowcharts of methods for detecting attacks on a satellite navigation system, according to respective embodiments of the invention;

FIG. 8 is a simplified network diagram of an attack detection server in communication with client devices over a network;

FIG. 9 is a simplified flowchart of a method for detecting attacks on a satellite navigation system, according to embodiments of the invention.

### DESCRIPTION OF SPECIFIC EMBODIMENTS OF THE INVENTION

The present invention, in some embodiments thereof, relates to detecting satellite navigation spoofing attacks and, more specifically, but not exclusively, to detecting satellite navigation spoofing attacks by combining multiple types of analysis of parameters extracted from satellite navigation signals.

In some embodiments of the invention, GNSS spoofing attacks are detected by analyzing information obtained from a GNSS receiver, and, optionally, from other sources. The analysis determines whether a spoofing attack is in progress. Once a spoofing attack is detected, control actions may be taken to mitigate the effects of the attack.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a device, a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages, including interpreted languages such as the “Python” programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (such as LAN, wired or wireless) or a wide area network (WAN), or the connection may be made to an external computer (for example, through the Internet using an Internet Service Provider or a cellular telephone operator). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. We have ASIC in the description of your invention below.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### I. Attack Detection

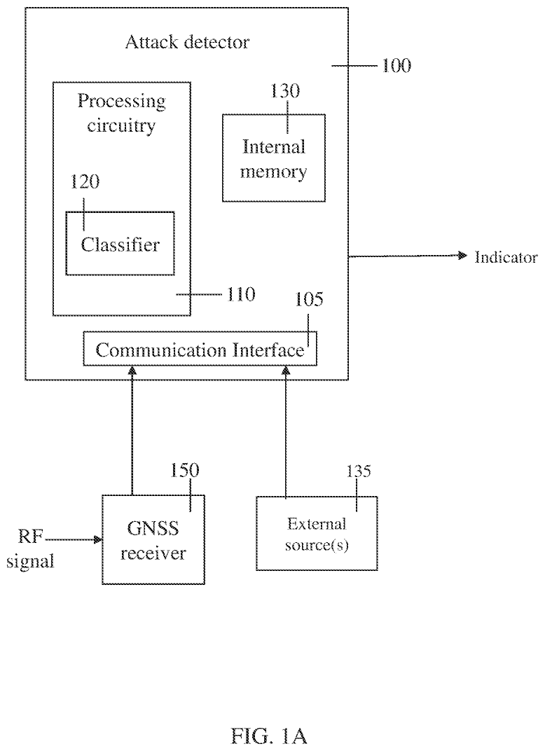

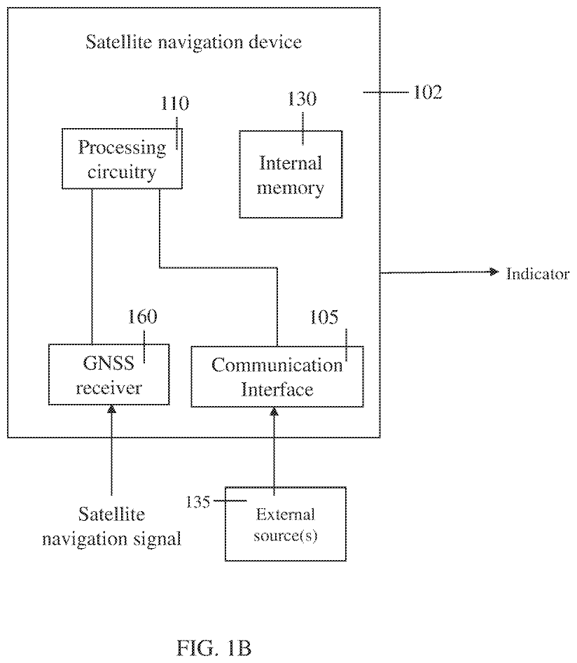

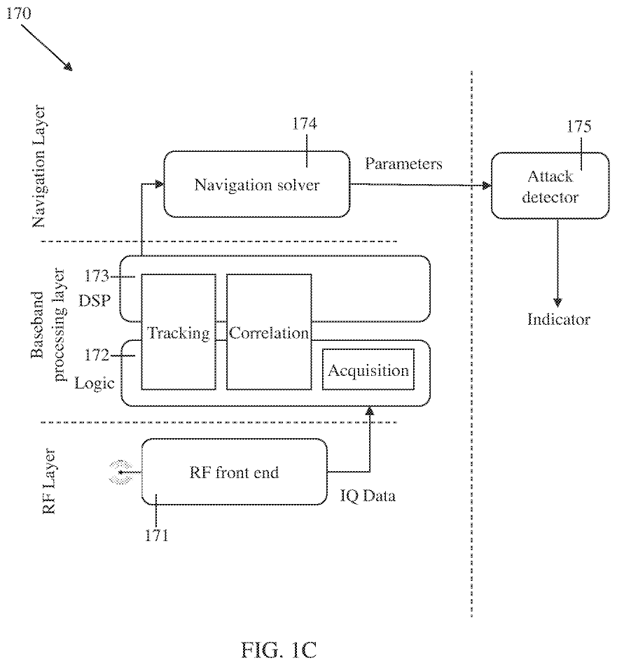

Reference is now made to FIG. 1A which is a simplified block diagram of a device for detecting attacks on a satellite navigation system, according to embodiments of the invention. Attack detector 100 includes communication interface 105 and processing circuitry 110.

Attack detector 100 detect attacks on the satellite navigation system by analyzing parameters of the satellite navigation signal. Attack detector 100 obtains some or all of the parameters from external GNSS receiver 150 and/or from other devices or systems, denoted herein external sources. When the analysis indicates that an attack is in progress (i.e. the satellite navigation signal is being spoofed), an indicator is issued.

As used herein the term “parameter” means information (e.g., a state, a value, a navigation message, a data set, etc.) that is analyzed to determine whether the satellite navigation signal is being spoofed.

The parameters may be obtained from a GNSS receiver and/or additional sources, as described below.

In some embodiments, the analysis includes inputting the obtained parameter values into a classifier (illustrated schematically as classifier 120) which has been trained to detect spoofing attacks, as described in more detail below.

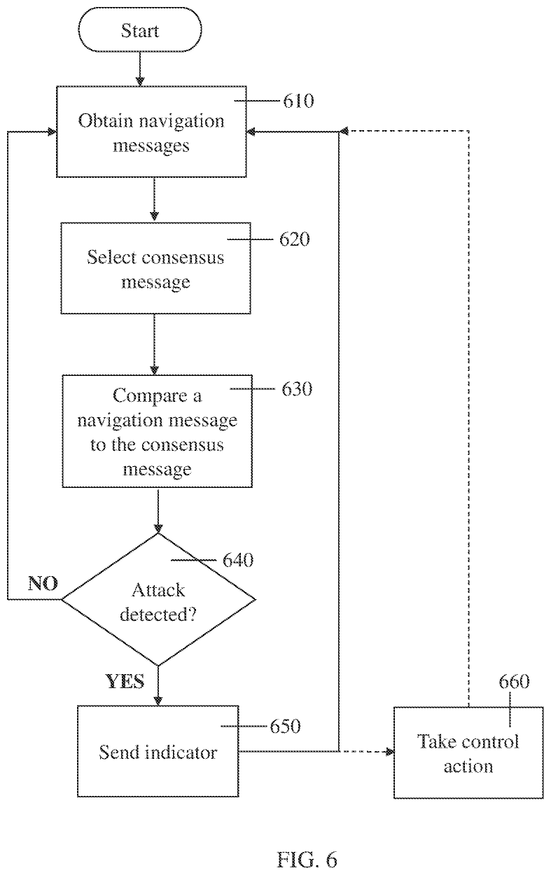

In alternate or additional embodiments, the analysis includes comparing a specific navigation message to a consensus navigation message. Differences between the specific navigation message and the consensus navigation message may indicate that a GNSS spoofing attack is underway. An exemplary embodiment is presented in FIG. 6.

Optionally, the indicator is issued to a device having satellite navigation capabilities (denoted herein a satellite navigation-enabled device). Examples of satellite navigation-enabled devices include but are not limited to: automobile, truck, ship, airplane, time server, mobile phone, tablet, camera, laptop computer, etc.

Optionally, the indicator includes a trigger signal which triggers the device receiving the indicator to take control actions to mitigate the attack. Examples of control actions are presented below.

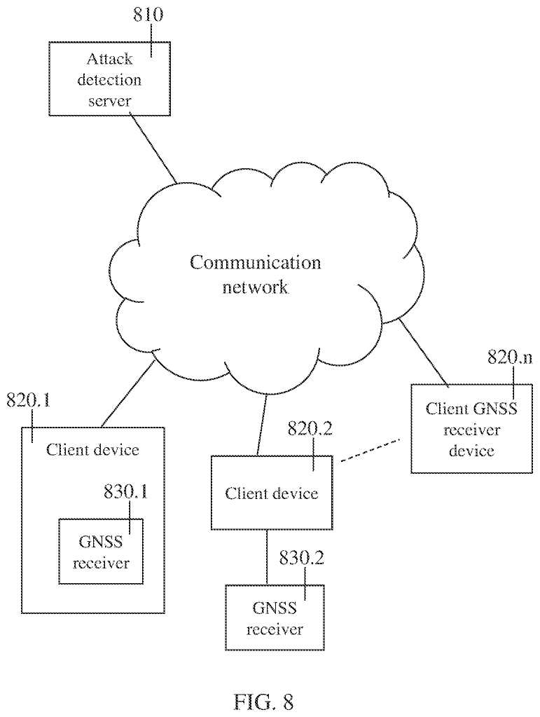

Optionally, attack detector 100 is integrated into a server which receives information from multiple client devices and issues indicators to one or more of the client devices when an attack is detected. In this embodiment, the parameters analyzed by attack detector 100 may be obtained directly from a GNSS receiver and, alternately or additionally, may be obtained by attack detector 100 by communication with a client device (e.g., a computer). An exemplary embodiment is presented below (see FIG. 8).

Communication interface 105 performs one or more of:
1) Outputting the indicator to an external device, for example to a server or satellite navigation-enabled device (e.g., a mobile phone, camera, dedicated satellite navigation device, etc.);
2) Inputting parameters and/or other information from GNSS receiver(s);
3) Inputting parameters and/or other information from external source(s); and
4) Receiving satellite navigation signals.

Optionally, attack detector 100 includes internal memory 130 which stores at least one of:
1) Code instructions which when executed by the processing circuitry cause it to perform some or all of the tasks described herein;
2) Parameters and/or other data used for the attack detection analysis; and
3) Information regarding the spoofing detection analysis, for example a trained classifier and/or rule(s) and/or model(s) as described in the embodiments below.

Optionally, attack detector 100 communicates with at least one external memory. External memory 135 may store one or more of: the code instructions, parameters, classifier information and other data used for attack detection.

Reference is now made to FIG. 1B, which is a simplified block diagram of a satellite navigation device, according to embodiments of the invention. Satellite navigation device 102 integrates both GNSS receiver 160 and processing circuitry 110 for performing attack detection. GNSS receiver 160 receives and processes RF signals and extracts parameters (such as PRN number, navigation messages, pseudoranges, etc.) from the received signal. Satellite navigation device 102 performs the attack detection by analyzing the navigation signal parameters extracted by GNSS receiver 110, optionally with additional information obtained from external sources. An indicator is issued when the analysis indicates that an attack is in progress.

Optionally, the indicator is issued to another device having satellite navigation capabilities (denoted herein a satellite navigation-enabled device). Examples of satellite navigation-enabled devices include but are not limited to: automobile, truck, ship, airplane, time server, mobile phone, tablet, camera, laptop computer, etc.

Optionally, the indicator includes a trigger signal which triggers satellite navigation device 102 to take control actions to mitigate the attack.

In optional embodiments of the invention, processing circuitry 110 is implemented, in whole or in part, as:
1) An IP core in a GNSS chip, such as an Application-Specific Integrated Circuit (ASIC), field-programmable gate array (FPGA) or complex programmable logic device (CPLD), (optionally using programmed in instructions in a hardware description language and/or firmware that runs on such hardware);
2) Processing circuitry integrated into a GNSS receiver (e.g., as part of the application layer of the GNSS receiver);
3) A processor and/or processing circuitry of a computer running a software-based GNSS receiver (optionally programmed in API/SDK for a host operating system such as RTOS, tinyOS, iOS, Android, VxWorks, Linux, macOS or Windows); and
4) An embedded micro-controller optionally programmed in firmware.

Reference is now made to FIG. 1C, which is a simplified block diagram of a GNSS receiver in communication with an attack detector, according to an exemplary embodiment of the invention.

GNSS receiver 170 includes three layers:
1) RF Front End Layer—includes RF front end 171 which samples the analog RF signal and converts it into sampled navigation data, optionally in the form of in-phase and quadrature data (IQ). These samples enter the baseband processing layer.
2) Baseband Processing Layer—includes logic unit 172 and DSP 173 which together perform acquisition, correlation and tracking, and provide the navigation data to navigation solver 174.
3) Navigation Layer—includes navigation solver 174 which solves the navigation equations, outputs geographic locations (e.g., PVT) and, optionally, other parameters which are used by attack detector 175 to detect if an attack is in progress.

### II. Parameters

Optionally, the types of parameters that may be obtained from a GNSS receiver and used for attack detection analysis include but are not limited to one or more of:
1) Navigational information computed by the GNSS receiver;
2) Characteristic(s) of the received satellite signal;
3) Characteristic(s) of the GNSS receiver;
4) Internal setting(s) of the GNSS receiver;
5) Data decoded from the satellite signal;
6) Sampled navigation signal (e.g., In-phase and Quadrature RF data);
8) Pseudoranges;
9) Pseudorange residuals;
10) Carrier phase;
11) Code phase; and
12) Navigation message(s).

Optionally, the parameters are obtained from the GNSS receiver as text messages in NMEA format. Alternately or additionally, at least one of the parameters is provided by the GNSS receiver in a vendor-specific format (e.g., a binary message, raw GNSS measurements, etc.).

Default parameters that are available from the GNSS receiver in the industry-standard NMEA format include:
1) Latitude, Longitude, Altitude, Velocity, Heading, Time and Date;
2) Geometric Dilution of Precision (GDOP)—for example horizontal dilution of precision (HDOP), vertical dilution of precision (VDOP), position (3D) dilution of precision (PDOP) and time dilution of precision (TDOP);
3) Satellite SNR (Signal to Noise Ratio) after dispreading and correlation; and
4) Azimuth and Elevation.

Some GNSS receivers provide additional parameters including but not limited to:
1) Accumulated Delta Range (m), Accumulated Delta Range Uncertainty (m);
2) Automatic Gain Control Level (Db);
3) Carrier Frequency (Hz);
4) Carrier Phase, Carrier Phase Uncertainty;
5) Carrier power to noise power spectral density ratio (C/N₀);
6) Constellation Type;
7) Multipath Indicator;
8) Pseudorange Rate (m/sec), Pseudorange Rate Uncertainty (m/sec);
9) Received space vehicle (SV) Time (ns), Received SV Time Uncertainty (ns); and
10) Time Offset (ns).

### III. External Sources

Optionally, attack detection is based on the parameters obtained from the GNSS receiver in combination with the information obtained from the external source(s). For example, information obtained from the external sources may be provided as additional input to a classifier.

Optionally, the information from the various sources is prioritized, for example by applying weightings according to the certainty of the data. Thus parameters obtained from a GNSS receiver (which is vulnerable to spoofing) may be given lower priority than information from sources that are immune to GNSS spoofing.

Examples of external sources include but are not limited to:
1) A mobile communication device;
2) A mobile communication cell tower;
3) A navigation device;
4) A motion sensor;
5) A rotation sensor;
6) A magnetic sensor;
7) An odometer;
8) An inertial measurement unit;
9) A barometer;
10) A compass;
11) A steering wheel angle sensor;
12) A camera;
13) At least one localization image;
14) A computer device.

It is noted that some external sources may be integrated into the attack detector, for example the motion and/or rotation and/or magnetic sensors.

### IV. Analysis Mechanisms

The embodiments presented herein describe many techniques for analyzing the satellite navigation signal parameters and/or data obtained from other sources in order to detect attacks on a satellite navigation system.

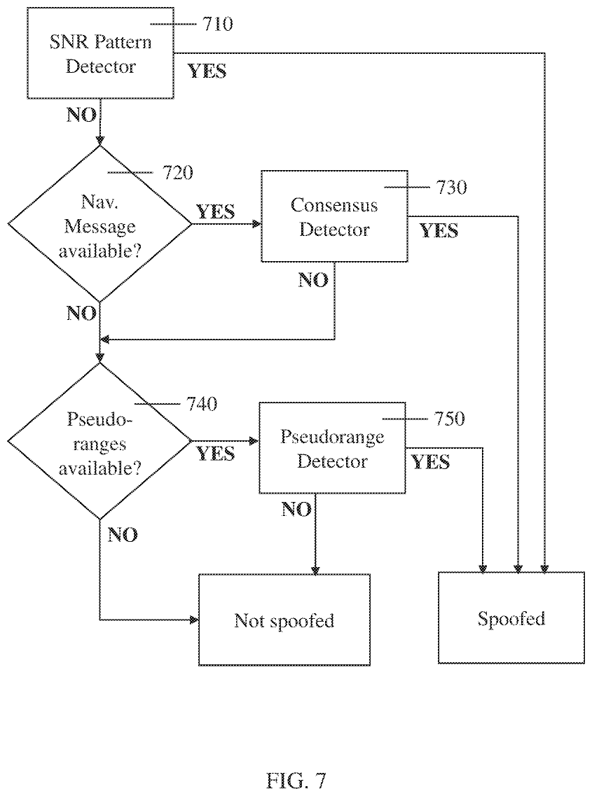

These techniques may be combined to provide a broad solution to the problem of detecting satellite navigation attacks by investigating the gathered information from many directions and with multiple mechanisms (for example see FIG. 7).

### IV.1. Navigation Message Consensus

Navigation message consensus is based on a comparison of corresponding navigation messages obtained from multiple sources. These sources may be a large user base (e.g., a fleet of cars or mobile phone users) and/or a small number of highly trusted sources. Attacks are detected by comparing a specific navigation message to a consensus navigation message selected from a set which includes navigation messages provided by multiple source devices.

As used herein the term “corresponding navigation message” means a navigation message which provides information which may be used to determine the legitimacy of a different navigation message. A non-limiting example of corresponding navigation messages are navigation messages provided by different satellite navigation devices having the same (or close) transmission timing information (e.g., TOW) as the navigation message being checked for legitimacy.

As used herein the term “consensus navigation message” means a navigation message which is considered to be a legitimate navigation message that was transmitted by a navigation satellite. The consensus navigation message serves as a standard for determining the legitimacy of other navigation messages.

Navigation messages are the actual data bits sent by a GNSS satellite. In current GNSS systems, the navigation message data bits are XORed with a pseudorandom PRN code (aka “a gold code”) and the output is modulated (e.g., BPSK for GPS L1 or BOC for Galileo E1) and transmitted to earth. The navigation message contains information about the entire GNSS constellation (the Almanac) and the satellites' orbit and clock parameters (the Ephemeris). This data is required by a GNSS receiver in order to solve the navigation equations and provide an accurate Positioning, Navigation, and Timing (PNT) solution.

Since not all of the data bits in the navigation message are required by the receiver (e.g., reserved data bit for future use), it is possible to “spoof” a navigation message. In most of the spoofing cases, the spoofed navigation message will not be completely identical to the one sent by a GNSS satellite. Spoofing the navigation message is referred to as “data spoofing”.

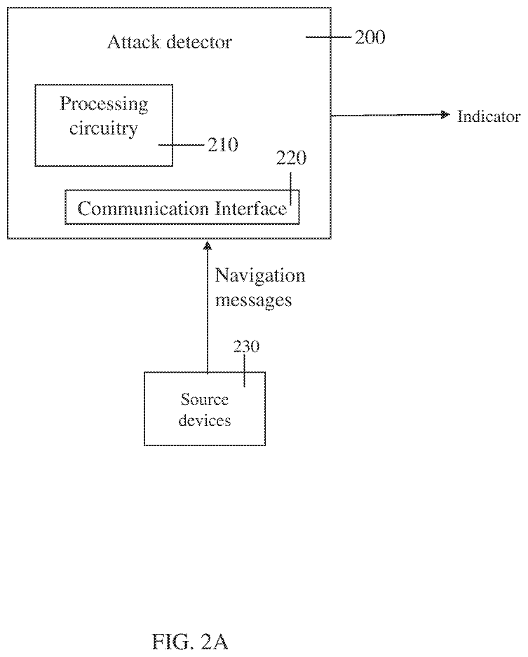

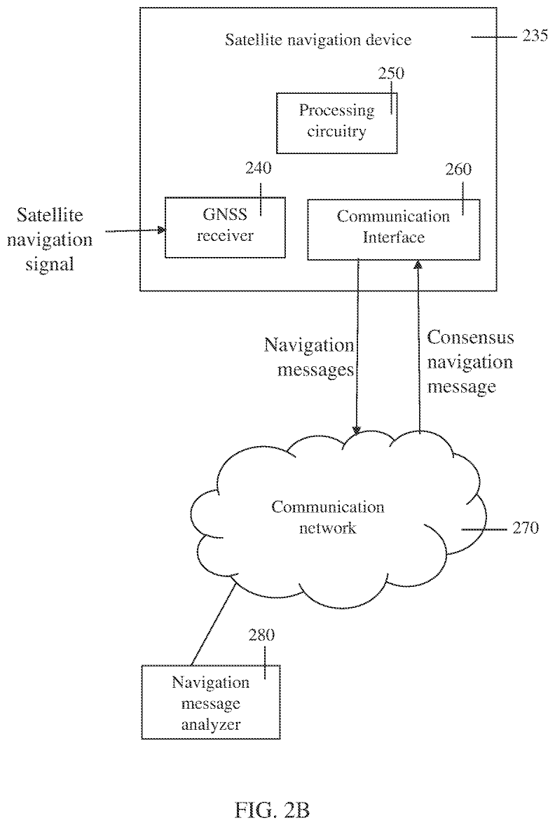

Reference is now made to FIG. 2A, which is a simplified block diagram of an attack detector, in accordance with an exemplary embodiment of the invention. Attack detector 200 includes processing circuitry 210 and communication interface 220 for communicating with source devices.

Attack detector 200 obtains navigation messages extracted by multiple source devices 230 from satellite navigation signals. A consensus navigation message is selected from a set of the obtained navigation messages. The set includes corresponding navigation messages, so that an analysis of the messages in the set may give information about which of the members of the set are legitimate navigation messages.

When the set includes a single navigation message for each source device, all the devices have equal influence on which navigation message is selected as the consensus navigation message. However, in some cases some source devices may be more trusted than others. Navigation messages provided by the trusted sources may be given more weight when selecting the consensus navigation message. One way to give more weight to navigation messages from a trusted source device is to include more than one copy of the navigation message received from the device in the set.

In some embodiments, the set includes one navigation message per source device. The consensus navigation message is the navigation message having the maximum count in the set. In other words, the consensus navigation message is the navigation message that was obtained from the majority of the source devices.

In alternate embodiments, the source devices are assigned respective weightings which indicate the number of times a navigation message sent by that source device should be included in the set. The consensus navigation message is the navigation message having the maximum count in the set.

When a navigation message obtained from a source device differs from the consensus navigation message, attack detector 200 sends an indicator of a spoofing attack to at least one source device. For example, the indicator may be sent to the source device that provided the navigation message and optionally to other devices in the vicinity of the source device that provided the navigation message.

Optionally, navigation messages must satisfy specified constraints in order to be included in the set. For example, all of the navigation messages included in the set must have the same Time Of Week (TOW). Alternately or additionally, the navigation message is checked to ensure it is bit-wise valid (i.e., the parity/checksum bits are correct).

Optionally, attack detector 200 performs other type(s) of analysis on the obtained navigation messages to determine if they are spoofed. Navigation messages that are determined to be spoofed are not included in the set.

For example, attack detector may analyze parameters obtained from a GNSS receiver (e.g., a source device) to detect spoofed navigation messages. Non-limiting examples of the parameters include:

i) Navigational information computed by the GNSS receiver (e.g., location of source device);

ii) Physical characteristics of the received satellite signal (e.g., signal quality); and

iii) Data decoded from the satellite signal (e.g., pseudorange, TOW).

Alternately or additionally, attack detector 200 also analyzes data from at least one source device sensor. Source device sensors include by are not limited to:

1) An inertial measurement unit (IMU);

2) A motion sensor;

3) A rotation sensor;

4) A magnetic sensor;

5) An odometer;

6) A barometer;

7) A compass;

8) A steering wheel angle sensor; and

9) A camera.

Optionally, attack detector 200 receives a query from a source device whether a specific navigation message extracted by that device is spoofed. If the navigation message is different from the corresponding consensus navigation message, attack detector 200 returns an indicator to the querying source device that the navigation message is spoofed (i.e. an attack has been detected). Optionally the query includes the specific navigation message and timing information (e.g., TOW) which enables attack detector 200 to identify the corresponding consensus navigation message.

In an exemplary embodiment, attack detector 200 obtains the navigation messages from a consensus network of users. The consensus network comprises:

1. An ordinary user base;

2. Trusted users; and

3. Centralized and/or distributed consensus servers.

The users send (or publish) the navigation messages from their local/internal receiver to the consensus server where they are received, analyzed, and saved into a database by the consensus software. The response from the server to the user is “spoofed”, “not spoofed” or “unreliable”.

The flow:
1. A user with a device registers for the service.
2. The user is assigned a unique user identifier (UUID).
3. When a navigation message becomes available to the user, it is sent as a data packet to the server by means of an API over a secure channel (e.g., HTTPS, SSH Tunnel, VPN). The data packet contains a timestamp (e.g., Android or Linux timestamp) obtained from the user's device and not from the navigation message.
4. The user waits for a response from the server.
5. The server receives the data packet from the user.
6. The server decodes the data packet and extracts the navigation message.
7. The server analyses the navigation message for common and known spoofer patterns in each frequency, constellation and message code (e.g., in GPS: LNAV-L, LNAV-U, CNAV, CL, ML. In Galileo: F/NAV, I/NAV/C/NAV. In BeiDou: D1, D2. In Glonass: C/A, P). Non-limiting examples of analyses that may be performed on GPS L1 C/A LNAV-L code navigation messages to detect navigation message spoofing:
   a. Decode the telemetry (TLM) word from the message. If the TLM word equals to any of the following, a “spoofed” flag is associated with the message:
      i. TLM Preamble=b′1000 1011′ (binary notation)
      ii. TLM Message=b′000 000′ (binary notation)
   b. Decode the reserved bits field in each subframe (in applicable subframes). If the bits match a known pattern (optionally stored in the attack detector's database) associated with a spoofer or a commercial GNSS simulator, a “spoofed” flag is associated with the message. An example of a known pattern used by simulators: 0xAAAAA (hex notation) or 0xAAAA (hex notation) in words 4, 5 and 6 in subframe 1.
   c. Decode the Time Of Week (TOW) from the navigation message. If the TOW does not represent the current time within a certain threshold (derived from the network latency), a “spoofed” flag is associated with the message (i.e. spoofing is detected).
   d. Decode subframe 4 and subframe 5. Check if the PageID time complies with the public GPS Interface Control Document (ICD).
8. A navigation message received from a normal user will have a weight of 1.
9. A navigation message received from a trusted source will have a weight that is in inverse proportion to the number of normal users in its vicinity and has a linear relationship to the total number of users in the system, i.e., the more users there are, the lower the weight.
10. If no known patterns were detected, the server software will compare (e.g., bitwise or specific fields) navigation messages that have the same TOW value within a certain timeframe.
   a. Identical messages are counted and multiplied by their respective weights.
   b. After weighting, the consensus navigation message is elected by normal majority.
11. Any incoming message from a user is compared to the consensus navigation message. If they are not the same, a “spoofed” indicator is associated with the message.

Reference is now made to FIG. 2B, which is a simplified block diagram of a satellite navigation device, in accordance with an exemplary embodiment of the invention. Satellite navigation device 235 includes GNSS receiver 240, processing circuitry 250 and communication interface 220 for communicating over network 270.

GNSS receiver 240 receives a satellite navigation signal and extracts navigation messages from the satellite navigation signal.

Satellite navigation device 235 sends the extracted navigation messages to navigation message analyzer 280 over the network 270. Navigation message analyzer 280 returns a consensus navigation message and a timing parameter of the consensus navigation message. Optionally the timing parameter is the TOW of the consensus navigation message.

Satellite navigation device 235 detects a spoofing attack by comparing a navigation message extracted by GNSS receiver 240 with the consensus navigation message having a corresponding timing parameter (e.g., the same TOW).

Optionally, when satellite navigation device 235 detects a spoofing attack it performs actions in order to mitigate the attack. For example, all PRNs with navigation messages which differ from the corresponding consensus navigation message are deleted and PNT calculation is performed using the non-spoofed PRNs.

Optionally, satellite navigation device 235 periodically pushes navigation messages extracted by GNSS receiver 240 to navigation message analyzer 280.

### IV.2. Pseudorange Local Consensus

Pseudoranges are the actual measurements derived from the time of flight of the message arriving from the satellite. Spoofing the pseudoranges is referred to as “range spoofing”. Since not all GNSS receiver will provide the navigation message, most will provide the pseudoranges. When a spoofer is activated, all of the receivers within its range will calculate the same PNT solution since they all receive the same spoofed signal transmitted from a nearby source.

In some embodiments of the invention, pseudoranges are sent by multiple source devices to a centralized attack detection server for comparison. If a large enough number of users report the same pseudorange, spoofing is detected.

### IV.3. GNSS Based Mechanisms

Attack detection may alternately or additionally be based on an analysis of parameters supplied by the GNSS receiver. Non-limiting examples of the parameters include:

i) Navigational information computed by the GNSS receiver (e.g., location of source device);

ii) Physical characteristics of the received satellite signal (e.g., signal quality); and

iii) Data decoded from the satellite signal (e.g., pseudorange, TOW).

Such GNSS-based analyses include but are not limited to the following examples.

### i) SNR Patterns

If the SNR of the majority of received PRNs is exactly the same, a spoofer is detected.
If the SNR rate of change is extremely high, a spoofer is detected.
If the SNR changes have a Gaussian distribution, a spoofer is detected.

### ii) Automatic Gain Control (AGC) to SNR Relationship

If the AGC level is going down while the SNR value of PRNS increases or does not change dramatically, spoofing is detected.
Filtering may be used to avoid false positives.
   iii) Theoretical SNR vs Received SNR

The SNR may be predicted according to a deterministic model. This model is used by spoofers to generate the spoofed signal. In reality, the received SNR rarely (if ever) matches the theoretical values. If it does, it is a clear indication of spoofing since the spoofed signal originates from a terrestrial source that is in close proximity to the target being spoofed.

### iv) Calculate PNT For Each Constellation

A GNSS receiver provides the raw measurements in the form of either a pseudorange (the assumed range to the SV) or SV time (the flight time of the signal) plus the receiver hardware clock. The SV time is used to calculate the PNT for each constellation separately. If the deviation is beyond a predefined threshold, spoofing is detected.

### v) Calculate Pseudoranges Based on Reported Position

A device having several location providers (GNSS, Wi-Fi, Cellular, etc.) or a GNSS receiver that is not fully effected by the spoofer, will report a certain position. This position is used to calculate the pseudoranges of each PRN in each constellation. The reported pseudoranges are compared to the calculated pseudoranges. If the deviation is beyond a predefined threshold, spoofing is detected.

vi) Spoofing Ranges without Navigation Message

A spoofer may spoof only the ranges without any valid navigation message. If the SNR is good (i.e. the signal strength is high) but navigation messages cannot be decoded, spoofing is detected. Typically when navigation messages cannot be decoded the SNR values are low.

vii) DOP as a State Change Indicator

Dilution of precision of one or more kinds (horizontal, vertical, position, or time) and the geometric continuity/discontinuity level are used to identify the variation between true (satellites) position solution and false (spoofer) position solution. If the variation is above a certain threshold, spoofing is detected.

viii) Compare Elevation to DTM

If the elevation reported by the receiver does not match the elevation obtained from a Digital Terrain Map (DTM), spoofing is detected.

### ix) Solution Accuracy

The GNSS receiver calculates the accuracy of the reported PNT solution. Many times, spoofers generate low-quality signals (bad clock, no 1 PPS sync, high local oscillator drift) that are picked up by the receiver, they exhibit very good SNR values and the NAV message is being decoded. But the overall accuracy of the solution exceeds logical limits. In this case, a predefined threshold crossed for a certain duration is detected as spoofing.

### x) Time

Compare the calculated time to trusted server time. If the times differ, spoofing is detected.

xi) Compare Doppler Shifts from Different Sources

A spoofed signal originating from a spoofer will not have the same Doppler shift as a signal transmitted by a satellite. A theoretical model Doppler shift is calculated for each PRN and compared to all tracked Doppler shifts of the same PRN (in the presence of a spoofer, the same PRN may be tracked multiple times). If the difference between the model and the received shifts is not the same, spoofing is detected.

### IV.4. Sensor-Aided Detection Mechanisms

In sensor-aided detection the attack-detection analysis is further based on additional information obtained from sensors in the GNSS device. Source device sensors include by are not limited to:
1) An inertial measurement unit (IMU);
2) A motion sensor;
3) A rotation sensor;
4) A magnetic sensor;
5) An odometer;
6) A barometer;
7) A compass;
8) A steering wheel angle sensor; and
9) A camera.

### i) Short-Term Dead-Reckoning Prediction to GPS

Using the device's built-in IMU, perform double integration of the accelerometer readings (corrected with orientation data from gyro) to obtain changes in position. Use the speed obtained from GPS as the initial conditions of the integration. Compare the predicted position to that obtained from GPS. If the error exceeds a threshold, spoofing is detected.

### ii) Mapping Data

During driving conditions, use vector mapping data to add a constraint on the possible location obtained from dead-reckoning. If the error exceeds a threshold, spoofing is detected.

iii) Detect No Movement
Using the device's built-in IMU, check if:
All 3-axis accelerometer readings changes are below a threshold, such as 0.005 g RMS
All 3-axis gyro readings changes are below a threshold, such as 0.001 rad/s RMS
All 3-axis magnetometer reading changes are below a threshold, such as 1 uT RMS
   If all are true AND the location changes, detect spoofing.

### iv) Detect Movement on a Desk

Using the device's built-in IMU, check if:
Pitch and roll changes are below 0.001 rad/s RMS
Yaw changes are very big
Z-axis accelerometer readings are below 0.1 g RMS
X-axis and Y-axis accelerometer are very big
   If all are true AND the location changes, detect spoofing.

### v) Handheld Detection

When a mobile device is held in hand and being used, the taps on the phone register very unique accelerometer readings on the Z-axis as well as a logical range of orientations (e.g., facing up at an angle). In these cases, the handheld state is detected.

### vi) Detect Substantial Movement

Using the device's built-in IMU, check for short bursts of pre-defined gyro and accelerometer changes. If these changes correspond to patterns that indicate a walking or running activity and are very short and far between: If all are true AND the location changes, detect spoofing.

vii) Heading and Course Alignment

Using the IMU, it is possible to determine the heading of a device (a combination of magnetic field and orientation based on gyros). The GPS does not provide heading data but does provide course data (a vector of speed and direction between two consecutive locations).
In an automobile—In situations where the device is not moving relative to the car (e.g., on the car seat or in a phone holder and no handheld state was detected) and the location is provided with high accuracy, the heading of the phone should follow the course. If not, spoofing is detected.
Walking, handheld—While walking and navigating with a mobile device, a user will hold the phone at predefined orientations. Rapid movements are filtered. Long term averaging of the course and heading is compared. If there is a prolonged mismatch, spoofing is detected.
   viii) Barometer

The atmospheric pressure changes as a continuous function. When the location provided with large altitude changes while none are registered on the barometer, spoofing is detected.

### ix) Mobile Device Activity Type Classifiers

Mobile devices (e.g., mobile telephones running iOS or Android), typically have built-in activity type classifiers provided by the operating system. These classifiers are “black boxes” that provide an activity type (e.g., stationary, walking, running, cycling, automotive) and a confidence level.

The activity type information may be used to identify spoofing attacks. Examples include but are not limited to:
If the reported activity type is stationary for a pre-defined amount of time, the location accuracy is high and the location changes during that time, spoofing is detected.
If the reported activity is walking, running, cycling or automotive for a pre-defined amount of time, the location accuracy is very high and the location does not change at all, spoofing is detected.

To prevent false-positives, cases of rapid movements (e.g., sharp turns in the car, shaking, vibration) may be filtered.

### IV.5. Signals of Opportunity Detection Mechanisms

Signals of opportunity detection utilizes information that is obtained from other types of communication signals, in addition to the satellite navigation signals.

### i) Wi-Fi Based Detection

When movement is detected using the IMU but it is not possible to classify the nature of the movement, Wi-Fi signals may be used to anchor the location. If the Service Set Identifier (SSID) of a Wi-Fi network does not change while a large location jump is detected, spoofing is detected. Further analysis may be performed to address edge cases such as coverage of large areas such as shopping malls, airports, and university campuses and personal hotspots.

### ii) Cellular Based Detection

If a large movement is detected while the device is connected to the same cellID, spoofing is detected.

### IV.6. Classifier-Based Analysis

Optionally, at least some of the parameters obtained by the attack detector from the GNSS receiver and/or other sources are input into a classifier which detects satellite navigation spoofing attacks by analyzing the parameter values. When the classifier results indicate that an attack is in progress (i.e. the satellite navigation signal is being spoofed), the indicator is issued.

Optionally, the classifier incorporates one or more of the detection mechanisms disclosed herein, including but not limited to:
1) Neural network processing;
2) Rule-based analysis;
3) Physical modeling;
4) Data fusion;
5) Location cross-referencing;
6) Anomaly detection;
7) Server-based analytics; and
8) Comparison with navigation messages received by other GNSS receivers.
   Exemplary embodiments are presented below.

Optionally, the decision of whether an indicator should be issued is based on the results of multiple types of analysis. For example, an indicator may be issued when the neural network indicates a high likelihood of attack and location cross-referencing finds discrepancies between the GNSS location and other sources of location information.

Optionally, the classifier logic is defined and/or the classifier training is performed outside the attack detector and not as part of the attack detector functionality. The predefined classifier may be included as part of the attack detector hardware and/or as code instructions for execution by the processing circuitry.

i. Neural Network Training

A neural network which has been trained with a set of training data (denoted herein the training set) to identify when an attack occurs. The training set includes parameters that are indicative of the presence of attacks. The type of neural network and the training method may be selected to optimize the detection of specific type(s) of spoofing.

Two common architectures of neural networks are feed-forward and recurrent neural networks. Recurrent neural networks are well suited for time series analysis but training them is more complicated relative to training a feed-forward neural network.

Training neural networks is usually done using a back-propagation technique. Artificial intelligence may be used to solve issues for which it is hard to devise an analytical solution. For example, in many cases the relationship between parameters to the classification result is unclear by standard analysis techniques even though a relationship does exist.

Specifically, deep neural networks are superior to other machine learning approaches due to the fact that they require less expertise in statistics inference and probability theory compared to other machine learning approaches. Deep neural networks may find non-linear relationships between parameters and classification results.

In an exemplary embodiment, the classifier is trained to identify numerous scenarios based on selected GNSS parameters (e.g., SNR, clock drift, SNR noise). Types of trained scenarios include but are not limited to:
1. Driving/walking/running/cycling in urban environments and different terrains (flat/hills).
2. Driving/walking/running/cycling in rural environments and different terrains (flat/hills).
3. Driving/walking/running/cycling in downtown and different terrains (flat/hills).
4. Getting in and out of tunnels.
5. Getting in and out of parking garages.
6. Getting in and out of houses and buildings.
7. Riding trains.
8. Flying helicopters/planes.
   If the classifier is unable to identify any of the train sets, spoofing is suspected/detected.

Optionally, the classifier is trained to differentiate between several modes of motion. The following are some examples of common use cases using the IMU:
1. Lifting a mobile phone from a table.
2. Holding a mobile phone in a hand.
3. Moving within a building with a mobile phone.
4. Getting into and out of a car with a mobile phone.
5. Handling a mobile phone while driving.
   This classification aids in matching movement information with changes in location and enables the trained classifier if it can use the sensor data or if the data should be discarded (for example spinning a mobile phone while walking yields unusable IMU sensor data for spoofing detection.

### IV.7. Rule-Based Analysis

Specified rules are applied to some or all of the parameters input to the classifier. Types of rules which may be applied to one or more parameters include but are not limited to:

a) Checking if a parameter is within a specified range. If the parameter falls outside its range, this may indicate that a spoofing attack is occurring.

b) Checking if redundant data is absent from a navigation message—Navigation messages sent by GNSS satellites typically contain redundant data that is not required by the GNSS receiver but is nonetheless present in the navigation message. Spoofers typically do not transmit this data, so its absence may be indicative of a spoofing attack. If the redundant data is present in the navigation message, its validity may be verified in order to determine whether it is correct (e.g., verifying the almanac and data validity of the navigation messages).

c) Checking if data sequences repeat in multiple navigation messages—GNSS satellites transmit navigation messages. Typically, some of the data bits in the navigation messages are reserved for future use, are not required by the GNSS receivers and are not predictable. High-end simulators use these bits to let a receiver know that the origin of the transmission is from a simulator and not a real satellite. For example for the GPS L1 C/A Code LNAV message, they will usually use 0xAAAAA (hex notation) in words 4, 5 and 6 in subframe 1. Spoofers often do not bother to predict these reserved bits and simply fill those bits as a constant template of 1's and 0's. The classifier compares multiple navigation messages and determines whether fixed bit sequences recur in a specified location or locations of multiple navigation messages (e.g., in the locations of the reserved bits). If so, messages containing the fixed bit sequence(s) are identified as spoofed. Alternately or additionally, the bit sequence is compared to a specified template or templates, and if a correspondence is found the messages are identified as spoofed. The expected time to detect an attack is up to 30 seconds when compared to templates locally and up to 6 seconds in a client-server architecture.

As used herein the term “location of the reserved bits” means a location in the navigation message having undefined data content in the protocol of the satellite navigation system.

### IV.8. Physical Modeling

Some parameters obtained from the GNSS receiver are physical measurements of the real world. These parameters may be compared to a physical model describing their behavior. For example, parameters such as Doppler shift, pseudo ranges and signal quality may be modeled. Failure of the measured parameters to adhere to the model may indicate an attack.

### IV.9. Data Fusion

In data fusion, parameter data for the classifier is obtained from multiple sources. Different priorities and/or weights may be assigned to different types of information. For example, both a GNSS receiver and an odometer are capable of reporting movement. In a non-spoofed environment both the GNSS receiver and the odometer should report the same movement (within some threshold error). If there is a significant difference between the movement reported by the GNSS receiver and the odometer, this may be a sign of spoofing. Therefore, movement information provided by the odometer may be given higher priority than movement information provided by the GNSS receiver. The same applies to the compass readings for direction changes and the barometer reading for altitude changes.

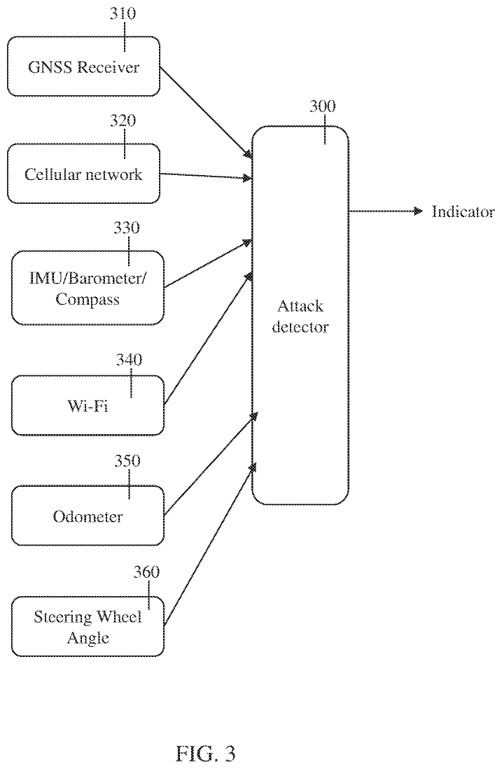

FIG. 3 illustrates data fusion, in which attack detector 300 receives information from GNSS receiver 310, cellular network 320, inertial measurement unit (IMU) and/or barometer and/or compass 330, Wi-Fi 340, odometer 350 and steering wheel angle sensor 360. The information received from multiple is input to the classifier.

### IV.10. Location Cross-Referencing

Cellular networks have cell towers in well-known geographical locations. If a system with cellular connectivity is connected to a certain cell tower with a known geographical location but the GNSS reports a location that is not within the range of the cell tower, spoofing is indicated. Similar location cross-referencing may be performed with Wi-Fi hotspots and Bluetooth beacons having known geographical locations. Another source of geographical location in some autonomous systems originates from image-based systems like cameras, radars and LIDARs.

### IV.11. Anomaly Detection

Using domain specific deep neural network(s) and/or Gaussian mixture model(s) and/or hidden Markov model(s), anomalies are searched for across one or more of the parameters available from the GNSS receiver (e.g., Doppler shift, SNR levels of each satellite, difference between SNRs and the first, second and third derivatives of the SNR).

### IV.12. Server Based Analytics

In some configurations, attack detectors communicate with a server. The server analyzes information obtained from multiple attack detectors to detect anomalies. For example, a server may provide proof of location for a given attack detector based on the location of other attack detectors located in proximity. Alternately or additionally, the server may identify that spoofing is occurring when multiple attack detectors report the same location while moving.

The server-based analysis is provided to the classifier and may be fused with input obtained from other sources to make a final decision of whether to issue an indicator.

### V. Attack Mitigation

When an attack is detected, one or more control actions may be taken to mitigate its effects so that GNSS usage may be resumed at a later time (when the attack is over). For example, a vehicle may stop using GNSS navigation when an attack is detected, drive away from the affected area and then resume using GNSS navigation.

Optionally, when an indicator is issued, the processing circuitry performs at least one control action. Such control actions include but are not limited to:
1) Driving Interaction—In autonomous cars, when spoofing is detected, steering, breaking and acceleration commands stop relying on GNSS inputs.
2) Timestamp—Timestamps from other sources (e.g., cloud-based time servers, cellular networks, etc.) may be compared to the timestamp generated by the local GNSS receiver. A difference in the two times may indicate that a spoofing attack is occurring.
3) Vehicular communication—Communicate by vehicle-to-vehicle (V2V) and/or vehicle-to-everything (V2X) technologies with other nodes in the vicinity and query them for their location integrity and/or inform them of a spoofing attack.
4) Change Base Station—When an indicator is issued, attempt to connect to the cell tower closest to the spoofed position. If the connection is not achieved, there is a high likelihood that a spoofing attack is in progress. This approach reduces the likelihood of false positives (i.e. issuing an indicator when in actuality there is no attack in progress).
5) Improve Detection—Detection accuracy may be increased and become more reliable by basing the detection on input from other sensors (i.e. sensor fusion).

### VI. Methods for Detecting an Attack on a Satellite Navigation System

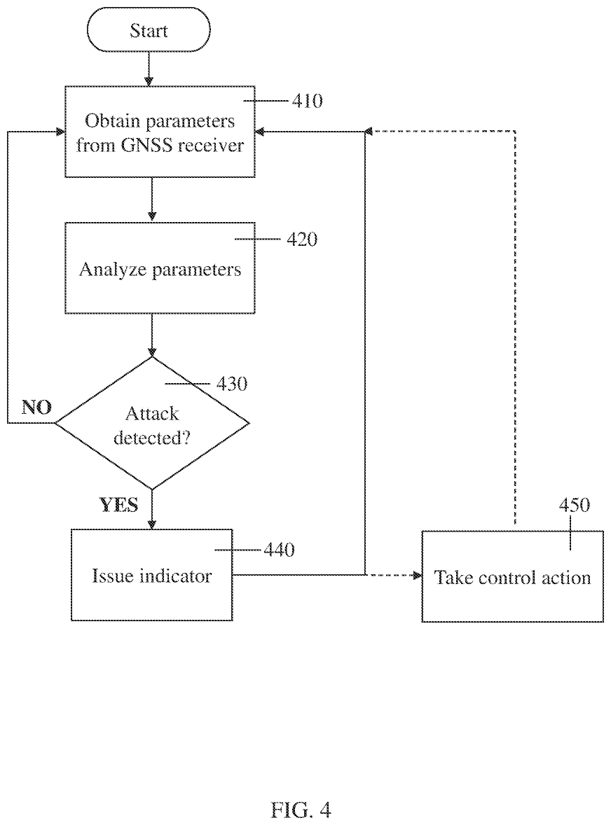

Reference is now made to FIG. 4, which is a simplified flowchart of a method for detecting attacks on a satellite navigation system, according to embodiments of the invention.

In 410, parameters extracted from a satellite navigation signal are obtained from a GNSS receiver.

In 420, the parameters are analyzed to detect an attack. Exemplary embodiments of performing the analysis using a classifier and by navigation message consensus are presented in FIGS. 4B and 4C respectively.

If an attack is detected in 430, in 440 an indicator is issued.

Optionally, in 450 a control action is taken when an indicator is issued.

Optionally, the parameters obtained from the GNSS receiver include one or more of:
1) Navigational information computed by the GNSS receiver;
2) Characteristic(s) of the received satellite signal;
3) Characteristic(s) of the GNSS receiver;
4) Internal setting(s) of the GNSS receiver;
5) Data decoded from the satellite signal; and
6) Sampled navigation signal (e.g., quadrature signals, IQ).
   Examples of parameters which may be obtained from a GNSS receiver are described above.

Optionally the classifier is based on one or more of:
1) Neural network processing;
2) Rule-based analysis;
3) Physical modeling;
4) Data fusion;
5) Location cross-referencing;
6) Anomaly detection; and
7) Server-based analytics,
   as described above.

Optionally, the method further includes obtaining data from at least one external source and providing it as additional input to the classifier. Attack detection is based on the parameters obtained from the GNSS receiver in combination with the parameter information obtained from the external source(s).

Optionally, an external source is:
1) A mobile communication device;
2) A mobile communication cell tower;
3) A navigation device;
4) A motion sensor;
5) A rotation sensor;
6) A magnetic sensor;
7) An odometer;
8) An inertial measurement unit;
9) A barometer;
10) A compass;
11) A steering wheel angle sensor;
12) A camera, and
13) At least one localization image.

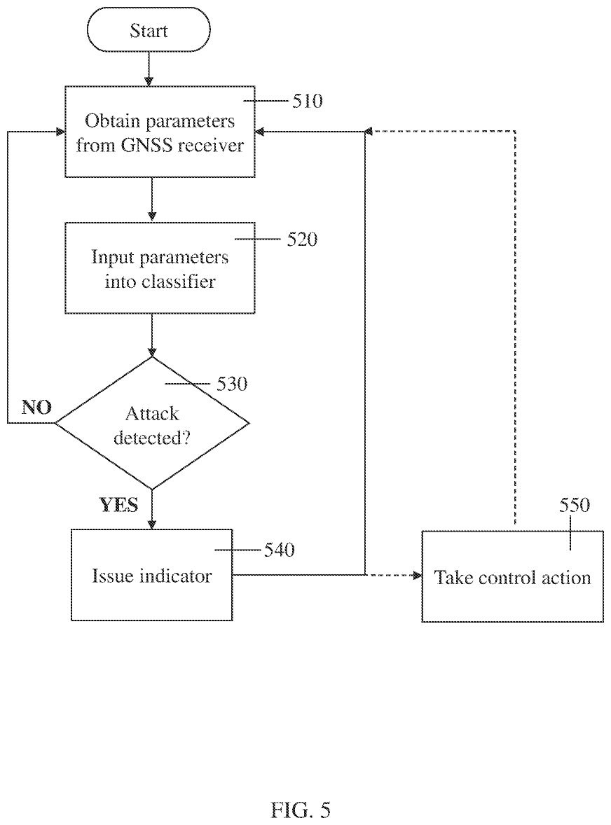

Reference is now made to FIG. 5, which is a simplified flowchart of a method for detecting attacks on a satellite navigation system, according to exemplary embodiments of the invention.

In 510, parameters extracted from a satellite navigation signal are obtained from a GNSS receiver.

In 520, the parameters are input into a classifier. The classifier is trained using a training set of parameters indicative of the presence of attacks.

If an attack is detected based on a result from the classifier in 530, in 540 an indicator is issued.

Optionally, in 550 a control action is taken when an indicator is issued.

Optionally, the parameters obtained from the GNSS receiver include one or more of:
1) Navigational information computed by the GNSS receiver;
2) Characteristic(s) of the received satellite signal;
3) Characteristic(s) of the GNSS receiver;
4) Internal setting(s) of the GNSS receiver;
5) Data decoded from the satellite signal; and
6) Sampled navigation signal (e.g., quadrature signals, IQ).
   Examples of parameters which may be obtained from a GNSS receiver are described above.

Optionally the classifier is based on one or more of:
1) Neural network processing;
2) Rule-based analysis;
3) Physical modeling;
4) Data fusion;
5) Location cross-referencing;
6) Anomaly detection; and
7) Server-based analytics,
   as described above.

Optionally, the method further includes obtaining data from at least one external source and providing it as additional input to the classifier. Attack detection is based on the parameters obtained from the GNSS receiver in combination with the parameter information obtained from the external source(s).

Optionally, an external source is:
1) A mobile communication device;
2) A mobile communication cell tower;
3) A navigation device;
4) A motion sensor;
5) A rotation sensor;
6) A magnetic sensor;
7) An odometer;
8) An inertial measurement unit;
9) A barometer;
10) A compass;
11) A steering wheel angle sensor;
12) A camera, and
13) At least one localization image.

Reference is now made to FIG. 6, which is a simplified flowchart of a method for detecting attacks on a satellite navigation system, according to exemplary embodiments of the invention. In 610, navigation messages extracted from satellite navigation signals are obtained from source devices. In 620 the consensus navigation message is selected by majority selection from a set of corresponding obtained navigation messages. In 630 the consensus navigation message is compared to a navigation message provided by a source device. If the navigation message provided by the source device is different from the consensus navigation message an attack is detected in 640, and an indicator of the spoofing attack is sent to at least one source device in 650.

Optionally, in 660 a control action is taken to mitigate the attack. For example, navigation messages obtained from source devices close to a device known to be under a spoofing attack may not be included in sets of navigation messages used to determine subsequent consensus navigation messages and/or the trust level of those devices might be lowered.

In some embodiments, the set includes one navigation message per source device. The consensus navigation message is the navigation message having the maximum count in the set.

In alternate embodiments, the source devices are assigned respective weightings which indicate the number of times a navigation message sent by that source device should be included in the set. The consensus navigation message is the navigation message having the maximum count in the set.

Optionally, the consensus navigation message is selected from navigation messages having a same TOW.

The method further includes performing additional analysis on the obtained navigation messages to determine if they are spoofed. Navigation messages that are determined to be spoofed are not included in the set. For example, spoofed navigation messages may be detected by analyzing at least one navigation signal parameter and/or sensor data obtained from the respective source device. Non-limiting examples of the parameters include:

i) Navigational information computed by the GNSS receiver;

ii) Physical characteristics of the received satellite signal; and

iii) Data decoded from the satellite signal.

Reference is now made to FIG. 7, which is a simplified flowchart of a method for detecting attacks on a satellite navigation system using multiple analysis mechanisms, according to exemplary embodiments of the invention. The analysis mechanisms used are SNR pattern analysis, navigation message consensus analysis and pseudorange analysis.

In 710, SNR data for the received satellite navigation signal is checked to determine whether it indicates a spoofing attack (e.g., SNR changes too rapidly).

If the SNR pattern does not indicate a spoofing attack and navigation message data is available (720), navigation message consensus analysis is performed by a consensus detector in 730.

If the consensus detector does not detect a spoofing attack and pseudorange data is available (740), the pseudorange information is analyzed by pseudorange detector in 750.

A spoofing attack is detected if any one of SNR Pattern Detector, Consensus Detector and Pseudorange detector detect an attack.

### VII. Attack Detection Server

In some embodiments of the invention, determining the legitimacy of navigation messages (i.e. attack detection) is performed by an attack detection server which communicates with multiple client devices.

Reference is now made to FIG. 8, which is a simplified network diagram of an attack detection server in communication with client devices over a network. In the example illustrated by FIG. 5, attack detection server 810 receives navigation messages from client devices 820.1-820.n. Client device 820.1 (e.g., an automobile or a mobile telephone with satellite navigation capabilities) includes GNSS receiver 530.1. Client device 520.2 (e.g., a computer) includes communicates with GNSS receiver 830.2. Client device 820.n is a GNSS receiver.

The client devices send navigation messages, and optionally additional information (such as time stamps), to attack detection server 810. The navigation messages and/or additional information enable attack detection server 810 to determine which navigation messages appear to have been transmitted at the same time. Because a navigation message transmitted from a satellite above a given geographical location is received identically by a GNSS receiver up to 5,000 km away (under satisfactory channel conditions), inconsistencies between a particular navigation message and corresponding messages from other client devices may indicate that the particular navigation message is spoofed.

A client device may query attack detection server 810 whether a particular navigation message it received is or is not spoofed (i.e. the spoofing state). The navigation message may have been previously provided by the client to attack detection server 810 or may be provided with the query (possibly along with additional information).

Alternately or additionally, the client device queries attack detection server 810 even if when it has not published information (e.g., a navigation message) to the server, and attack detection server 810 replies with a best-effort estimate of the spoofing state based on past data.

If the client device base is spread over a large geographic area, effective identification may be achieved with information provided by as few as a dozen client devices. The probability of detecting a spoofing attack improves as the number of client devices sharing their navigation messages increases. Expected detection time is under 6 seconds.

Optionally, some or all of the client devices push (i.e. publish) their respective data to attack detection server 810 (e.g., on a regular basis). Alternately or additionally, attack detection server 810 polls some or all of the client devices for their information.

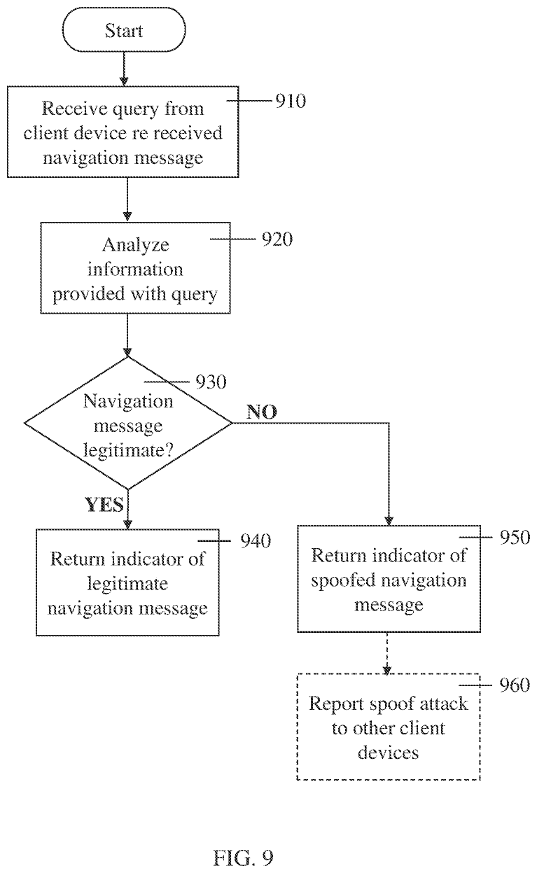

Reference is now made to FIG. 9, which is a simplified flowchart of a method performed by an attack detection server to detect attacks on a satellite navigation system according to embodiments of the invention.

In 910 a query is received from one of the client devices to check whether a navigation message is spoofed. The query includes information extracted from a navigation signal. Optionally the included information is the navigation message being checked and further optionally other information, such as time stamps, which enable the attack detection server to identify corresponding navigation messages which were received from other client devices.

In 920 the information provided with the query is analyzed by a classifier to determine whether the navigation message being checked is legitimate or spoofed.

Optionally, the classifier detects attacks by analyzing data sequences which repeat at a same location in corresponding navigation messages. Further optionally, the location is a location having undefined data content in the protocol of the satellite navigation system (e.g., reserved bits in the navigation message).

Optionally, the classifier detects and attack when the data sequences at the same location are extracted from navigation messages having the same (or substantially the same) transmission time information and were received by multiple geographically dispersed GNSS receivers. Alternately or additionally, the classifier detects an attack when the data sequences at the same location correspond to a specified sequence (e.g., template or templates).

Optionally, the analysis is performed by a trained classifier, which was trained using a training set which includes parameters indicative of the presence of attacks.

In 930-950, an indicator of whether the navigation message is legitimate or spoofed is returned to the client device based on the results of the analysis.

The determination that a single client is being spoofed does not necessarily mean other clients close by are also spoofed. In some embodiments the attack detection server does not push a spoofing state indicator to other client devices. Furthermore, client device(s) may only provide meta-data that does not allow the attack detection server to know where the client is located and therefore it is unable to send indicators to nearby client devices. In other cases it may be desirable to indicate to other client devices that they are or may be under a spoofing attack.

Optionally, in 960 when the navigation message is spoofed an indicator is sent to other client devices (e.g., other client devices which may be under the same spoofing attack), based for example on further analysis of parameters provided by a particular client device.

The legitimacy of the navigation message being checked may be determined by any of the mechanisms or combination of mechanisms described herein (e.g., a combination of rule-based analysis with anomaly detection). For example, a client device may be unable to detect a navigation message due to an attack that deliberately corrupts the navigation message but still lets the receiver track the signal and calculate a spoofed position. A spoofing attack is detected when the signal quality at the client device is good and the geographical location is accurate but no navigation message may be extracted from the signal.

Optionally, the legitimacy of the navigation message being checked is determined based on a consensus of corresponding navigation messages obtained by the attack detection server. In an exemplary embodiment, the attack detection server operates as a service to subscribed users and uses navigation message consensus to determine whether a particular navigation message is legitimate or spoofed. The attack detection server collects navigation messages from subscribed users of the service. A user queries the attack detection server (e.g., using an API) whether a particular navigation message, passed as an argument to the query, is or is not spoofed. The attack detection server decides whether the navigation message provided with the query is spoofed based on a majority vote, by comparing the navigation message in the query with a concurrent database of navigation messages from other users for the specific time. If there is no consensus, the API call to the user returns “spoofed”.

In summary, there are many types of spoofing techniques and spoofing scenarios in constant evolution. The above described embodiments provide an extremely robust detection method, which can combine analysis mechanisms to direct the attack detection to specific attack scenarios. Additionally, utilizing data obtained from multiple sources minimizes false positives (in which an indicator is issued when an attack is not taking place), providing an important benefit since the typical operating environment of a GNSS receiver is a non-spoofed one.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant satellite navigation systems, navigation messages, parameters obtainable from GNSS receivers, techniques for acquiring and tracking navigation messages, digital signal processors, processing circuitry, GNSS receivers (hardware and software) and IP core technology will be developed and the scope of the terms satellite navigation system, navigation message, parameter, acquisition, tracking, digital signal processor, processing circuitry and GNSS receiver are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An attack for detecting attacks on a satellite navigation system, comprising
a communication interface configured for communicating over a network; and
processing circuitry associated with said network interface configured for:
obtaining, over said network, navigation messages extracted from satellite navigation signals by a plurality of source devices;
selecting a consensus navigation message from a set of said obtained navigation messages by majority selection; and
sending an indicator of a spoofing attack to at least one source device when a navigation message obtained from said source device differs from said consensus navigation message.

2. An attack detector according to claim 1, wherein said set comprises a single navigation message for each respective source device and said consensus navigation message comprises a navigation message having a maximum count in said set.

3. An attack detector according to claim 1, wherein said set comprises, for each of said plurality of source devices, a respective specified multiple of a navigation message obtained from said source device and said consensus navigation message comprises a navigation message having a maximum count in said set.

4. An attack detector according to claim 1, wherein said set comprises navigation messages having a same Time Of Week.

5. An attack detector according to claim 1, wherein said processing circuitry is further configured for detecting spoofed navigation messages by analyzing parameters obtained from a GNSS receiver.

6. An attack detector according to claim 5, wherein said obtained parameters comprise at least one of:
navigational information computed by said GNSS receiver;
physical characteristics of said received satellite signal; and
data decoded from said satellite signal.

7. An attack detector according to claim 1, wherein said processing circuitry is further configured for detecting spoofed navigation messages by analyzing sensor data obtained from at least one of said plurality of source devices.

8. An attack detector according to claim 7, wherein said sensor comprises an inertial measurement unit.

9. An attack detector according to claim 1, wherein said processing circuitry is further configured for preventing inclusion of said spoofed navigation messages in said set.

10. A satellite navigation device, comprising:
a Global Navigation Satellite System (GNSS) receiver configured for receiving a satellite navigation signal and for extracting navigation messages from said satellite navigation signal;
a communication interface configured for communicating over a network; and
processing circuitry associated with said GNSS receiver and said network interface, configured for:
sending said extracted navigation messages to a navigation message analyzer over said network;
obtaining a consensus navigation message and a timing parameter of said consensus navigation message from said navigation message analyzer;
detecting a spoofing attack when an extracted navigation message corresponding to said timing parameter differs from said consensus navigation message.

11. A satellite navigation device according to claim 10, wherein said timing parameter comprises a Time Of Week of said navigation message.

12. A satellite navigation device according to claim 10, wherein said processing circuitry is further configured for periodically pushing extracted navigation messages to said navigation message analyzer.

13. A method for detecting attacks on a satellite navigation system, comprising:
obtaining, from a plurality of source devices, navigation messages extracted from satellite navigation signals;
selecting a consensus navigation message from a set of said obtained navigation message by majority selection;
sending an indicator of a spoofing attack to at least one source device when a navigation message obtained from said source device differs from said consensus navigation message.

14. A method according to claim 13, wherein said set comprises a single navigation message for each respective source device and said consensus navigation message comprises a navigation message having a maximum count in said set.

15. A method according to claim 13, wherein said set comprises, for each of said plurality of source devices, a respective specified multiple of a navigation message obtained from said source device and said consensus navigation message comprises a navigation message having a maximum count in said set.

16. A method according to claim 13, wherein said set comprises navigation messages having a same Time Of Week.

17. A method according to claim 13, further comprising detecting spoofed navigation messages by analyzing parameters obtained from a GNSS receiver.

18. A method according to claim 17, wherein said obtained parameters comprise at least one of:
navigational information computed by said GNSS receiver;
physical characteristics of said received satellite signal; and
data decoded from said satellite signal.

19. A method according to claim 13, further comprising detecting spoofed navigation messages by analyzing sensor data obtained from at least one of said plurality of source devices.

20. A method according to claim 17, further comprising preventing inclusion of said spoofed navigation messages in said set.
